(19) United States
(12) Patent Application Publication
(10) Pub. No.: US 2005/0129813 A1
(43) Pub. Date: Jun. 16, 2005

(54) Tubular double food envelope comprising transferable components

(75) Inventors: Martina Koenig, Wiesbaden (DE); Christian Auf Der Heide, Osnabrueck (DE); Dirk Auf Der Heide, Alfhausen (DE); Juerg-Heinrich Kallweit, Osnabrueck (DE)

Correspondence Address: CONNOLLY BOVE LODGE & HUTZ LLP, SUITE 800, 1990 M STREET NW, WASHINGTON, DC, 20036-3425, US

(73) Assignee: Kalle GMBH & Co. KG, Wiesbaden (DE)

(21) Appl. No.: 10/507,300

(22) PCT Filed: Apr. 11, 2003
(86) PCT No.: PCT/EP03/03766

(30) Foreign Application Priority Data
Apr. 17, 2002 (DE) 102 17 132.7

(51) Int. Cl. A23G 1/00

(52) U.S. Cl. 426/135

(57) ABSTRACT

The invention relates to a tubular double food casing. It comprises an outer barrier casing and an inner casing having at least one coloring, aroma substance and/or flavoring which is transferred to the food. It further relates to a shirred stick made of two successive segments, the first segment consisting of the shirred barrier casing and the second consisting of the shirred inner casing and the deshirred, or non-shirred, start of the second casing being passed through the cavity of the first segment and fixed to the start of the barrier casing.

The invention relates to a tubular food casing from which constituents can be transferred to the food situated thererin.

Food casings, especially sausage casings, frequently consist of natural gut skin, or of collagen which likewise is produced from animal sources. However, after the occurrence of animal diseases (BSE), there are reservations about casings made of such material. Nevertheless, foods in natural gut skin or collagen skin may generally be smoked well.

Furthermore, casings made of possibly fiber-reinforced regenerated cellulose or of synthetic polymers are widespread. Casings made of regenerated cellulose, however, are produced in complex and environmentally-polluting processes. Casings made of synthetic polymers, in turn, are usually only slightly permeable to oxygen and/or water vapor. They are generally impermeable to cold smoke or hot smoke. Casings made of other material, for example protein-coated or acrylate-coated fabric, have to date gained only slight importance.

Casings made of thermoplastic starch or a thermoplastic starch derivative are also known (EP-A 709 030). The starch or the starch derivative is generally mixed with a polymer obtainable by polycondensation or polyaddition (EP-A 1 054 599), in particular with a polyester urethane (DE-A 198 22 979).

Likewise known are food casings which have a coating, the constituents of which can be transferred to the food. For instance, WO 98/31731 and EP-A 986 957 disclose films which, on the side facing the food have a layer which contains a flavoring or aroma component and also a polysaccharide or protein as binder. The support layer of the films consists of polyolefin, polyamide, polyester, poly(vinylidene chloride) (PVDC), pol(vinyl chloride) (PVC) or polystyrene.

JP-A 139401/2000 describes a film by which food coloring may be transferred to sausage-meat emulsion, ham or similar foods. This is achieved by a coating which, in addition to the food dye, also contains an edible plasticizer, such as glycerol, sorbitol or propylene glycol.

DE-A 198 46 305 relates to a barrier casing made of a plastic material, the casing having on the inside a layer made of an absorbent material (woven fabric, knitwear or knitted fabric) which is impregnated with colorants or aroma substances. During cooking or scalding, the colorants or aroma substances are transferred to the food enclosed by the casing. The inner layer is generally bonded to the adjacent layer of the casing by an adhesive. The barrier casing itself consists, for example, of polyamide and polyethylene layers. It is generally produced from a corresponding flat film by hot sealing or bonding.

Cellulose-based tubular food casings are already described which, on the side facing the food, bear smoke and/or seasonings. These casings have a high permeability to water vapor and oxygen. A food situated in the casing therefore dries out relatively rapidly and has only a short shelf life.

All the known casings having inner layers or inner coatings which comprise a transferable food additive usually have the disadvantage that either their production is technically highly complex or that they cannot transfer the food additives in a sufficient amount.

The object is therefore to provide a seamless tubular food casing which has good barrier properties, in particular a high barrier to oxygen and water vapor, and using which colorants, aroma substances or flavor substances can uniformly be transferred in a sufficiently high amount to a food situated in contact with the casing. The casing should be able to be produced simply and inexpensively, as far as possible without adhesion or lamination. It should be able to be finally processed so that it can be stuffed without problem (in particular without preliminary soaking). The casing, in particular, should be able to be used in the production of stacked/sliced product.

The object is achieved by a double casing, that is to say a casing which comprises two casings lying one above the other, mechanically bonded together only in their respective start region. The outer casing essentially adopts the barrier function and imparts also most mechanical stability to the overall construction, while the inner casing serves as an intermediate support for the food additive.

The present invention therefore relates to a tubular food casing from which constituents can be transferred to the food present therein, which casing comprises an outer tubular barrier casing and an inner tubular casing which contains or carries a transferable colorant, aroma substance and/or flavoring.

Outer and inner casings are of approximately the same stuffing caliber, so that after stuffing they lie smoothly and free from creases against one another or on the stuffing.

The outer casing is preferably a seamless single-layer or multilayer casing made of polymer material having a low permeability to water vapor, oxygen and aroma substances, for example smoke aroma substances.

The nature of the outer casing is such that it effectively prevents the food from drying out during storage and simultaneously excludes the atmospheric oxygen. This object can be achieved by a (single-layer) casing based on polyamide, polyolefin, polyester, poly(vinylidene chloride) (PVDC), poly(vinyl chloride) (PVC), polystyrene, or corresponding copolymers. Preference is given to a casing based on polyamide or polyolefin. However, it must be taken into account that polyamide layers exhibit a high oxygen barrier, but only a relatively low water vapor barrier. With polyolefin layers, the situation is precisely the reverse. If a particularly high barrier action is to be achieved, it is therefore expedient to provide simultaneously at least one polyamide layer and at least one polyolefin layer.

Preferably, the outer casing is therefore a multilayer casing having at least one oxygen-barrier layer based on polyamide and at least one water vapor-barrier layer based on polyolefin. Particular preference is given to a three-layer casing in which the water vapor-barrier layer is the central layer, which is surrounded by oxygen-barrier layers. Suitable polyolefin materials for the water vapor-barrier central layer are in particular ethylene/vinyl alcohol (EVOH) and polyolefins, such as polyethylene, polypropylene, or copolymers containing units of polyethylene, polypropylene and/or α-olefins having 4 to 8 carbon atoms. Suitable materials are, in particular, C₂/C₃- and C₃/C₄-copolymers, C₂/C₃/C₄ terpolymers and mixtures thereof.

The oxygen-barrier layer is preferably a polyamide layer. This can contain aliphatic polyamide, aliphatic copolyamide or a mixture thereof. Examples of these are polycaprolactam (nylon 6), poly(hexamethylene adipamide) (nylon 66) and a copolyamide of caprolactam, hexamethylenediamine and adipic acid units (nylon 6/66). In addition the polyamide layers can contain partially or completely aromatic polyamides, for example a copolyamide of hexamethylenediamine, terephthalic acid and isophthalic acid (nylon 6I/6° T.). The content of the (partially) aromatic polyamides is generally no more than 40% by weight, based on the total weight of the polyamide layer. Furthermore, the polyamide layers can also contain other polymers, for example polyolefins, polyesters or ionomers. The content of the other polymers is preferably no more than 25% by weight, based on the total weight of the relevant polyamide layer.

Between the barrier layers there is also expediently relatively thin (0.5 to 5 μm) adhesion layers. They consist of or at least comprise an adhesion promoter. The outer casing in this case has five layers. Suitable adhesion promoters are, in particular, graft polymers or copolymers (in which case the term “copolymers” is also to cover polymers having more than 2 different monomer units) containing ethylene and/or propylene units and units of at least one comonomer from the group consisting of (meth)acrylic acid, (meth)acrylic acid esters, vinyl acetate and maleic anhydride. Preferred comonomers are, in particular, (C₁-C₆)alkyl (meth)acrylates, such as butyl acrylate. Rubber-modified polyethylene is also suitable. The content of units containing functional groups in the graft polymers or copolymers is generally 3 to 12% by weight, based on the weight of the adhesion-promoting component. The terms “(meth)acrylic acid” and “(meth)acrylate” here mean acrylic acid and/or methacrylic acid or acrylate and/or methacrylate. The adhesion promoter can also be a constituent of the abovementioned polyamide and/or polyolefin layer(s).

The outer casing generally has a thickness of 30 to 120 μm, preferably 40 to 90 μm. This applies to the single-layer and also to the multilayer embodiment. It is preferably stretched in an area ratio of 1:2 to 1:10 which is preferably achieved by blow forming. The outer casing generally has an oxygen permeability of 1 to 100 cm³/m² bar d, preferably of 1 to 15 cm³/m² bar d, determined as specified in DN 53380, and a water vapor permeability of 1 to 50 g/m² d, preferably of 1 to 10 g/m² d, determined as specified in DIN 53122. In order to be able to shirr better, and later also in order to be able to stuff better the food casing, it can be provided on the outside with an oil or lubricant, such as paraffin oil or glycerol. In addition, the outer casing can also be premoistened ready for use (polyamide layers absorb, for example, up to about 8% by weight of water). The premoistening in addition makes the outer casing more supple.

The casing coming into contact with the food does not necessarily contribute to the mechanical stability of the overall construction. However, it must in any case be stable enough that it does not tear on stuffing. It generally has no barrier properties, or only low barrier properties, to water vapor, oxygen and aroma substances (such as liquid smoke). Depending on the type of the food additives to be transferred, this inner casing can be made of regenerated cellulose, a mixture of thermoplastic starch and/or a thermoplastic starch derivative and other polymers (in particular polyurethane), of paper, textile fabric or nonwoven fabric. In a preferred embodiment the other polymer which is mixed with the thermoplastic starch or the starch derivative is a thermoplastic polyester urethane, as described in DE-A 198 22 979. The thermoplastic polyester urethane generally consists of hard polyurethane and soft polyester segments, the segments being arranged in alternating sequence. “Soft” means here segments having a glass transition temperature (T_{g}) of −20□C or below, “hard” in contrast means those having a T_{g} of +30□C or above. The polyester urethane can be of aliphatic or aromatic nature. The content of the polyurethane segments in the thermoplastic polyester urethane is 10 to 90% by weight, preferably 20 to 50% by weight, in each case based on the total weight of the polyester urethane. They generally consist of diisocyanate and diol units. The diisocyanate units can be aliphatic, cycloaliphatic or aromatic. Examples of aliphatic diisocyanates are butane 1,4-diisocyanate and hexane 1,6-diisocyanate. Isophorone diisocyanate (=3-isocyanatomethyl-3,5,5-trimethylcyclohexane isocyanate) is an example of a cycloaliphatic diisocyanate. Toluene 2,4- and 2,6-diisocyanate, diphenylmethane 2,2′-, 2,4′-, 2,6′- and 4,4′-diisocyanate and also naphthalene 1,5-diisocyanate are preferred aromatic diisocyanates. It is solely of importance that the inner casings can store or hold the substances which are to be transferred to the food, more precisely especially when the casing is shirred.

The inner casing can also be produced from a web-like flat material which is charged with one or more substances to be transferred and then formed into a tube. This procedure is particularly expedient because additives can be applied to a flat material web considerably simpler and more inexpensively in processing terms than to the inside of a tubular material. The tube formed from the flat web can be set by gluing, sealing or sewing the overlapping edges or in other ways familiar to those skilled in the art. The inner casing can therefore have a seam. The wall thickness of the inner casing is material-dependent. It is generally 30 to 200 Sun, preferably 40 to 100 μM. Fiber-reinforced cellulose casings generally have a wall thickness of 50 to 80 μm (before they are charged with liquid smoke or other substances).

The substance which can be transferred from the inner casing to the food (in particular the sausage-meat emulsion) can be a colorant, aroma substance and/or flavor substance, for example a spice or a spice mixture (such as pepper in whole grains, in coarse pieces or finely ground), a spice extract, liquid smoke or dry smoke which can also be modified (for example by adding alkaline agents and/or viscosity-increasing agents or by removing tar constituents), a natural or synthetic aroma, a flavor enhancer (for example glutamine) or another food additive. Liquid smoke, for example, usually absorbs into the inner casing. Suitable casings for liquid smoke are particularly (seamless) fiber-reinforced casings based on regenerated cellulose. Such casings are known and are commercially available. Solid substances, in contrast, are generally bound to the surface of the inner casing, expediently using binders. In addition it can be expedient to mix substances to be transferred (in particular solid substances) with a binder, or to enclose it therewith.

Accordingly, in a preferred embodiment, the transferable colorant, aroma substance or flavor substance is combined with a binder permitted by food law, in particular a polysaccharide (such as starch), a modified starch (such as carboxymethyl starch), dextran, pullulan, tragacanth gum, xanthan gum, gum arabic, alginate, methyl cellulose, hydroxyethyl cellulose, hydroxypropyl cellulose, carboxymethyl cellulose, chitin, chitosan, a protein (such as gluten), pectin, carrageenan, guar or gelatin. The type and amount of the binder or binder mixture depend on the colorant, aroma substance or flavor substance and may be optimized in simple preliminary experiments.

The binder can be mixed with the colorant, aroma substance or flavor substance. In some cases, for example if whole peppercorns or coarsely ground pepper are (is) to be transferred, it is expedient first to provide a layer of the binder and then to apply thereon the colorant, aroma substance or flavor substances alone or mixed with a further binder. The thickness of the binder layer depends on the type of component to be transferred.

To achieve uniform transfer of the colorant, aroma substance or flavor substances during cooking or scalding of the food, it has also proved to be expedient to add to these additives and/or the binder a component which deceases water solubility. For this purpose shellac, especially sheet shellac, is particularly suitable.

The colorants, aroma substances and/or flavor substances can be applied to the tubular casing by a number of processes, for example by spraying, printing, roller application, flocking, calendering or painting. A plurality of processes can also be combined.

The inventive double casing (tandem casing) is generally produced in such a manner that the inner and outer casings are first shirred, separately from one another, to form a shirred stick. The shirred sticks are then arranged immediately one behind the other. The deshirred (that is to say more or less smooth) or non-shirred start of the inner casing is passed through the cavity of the shirred stick formed by the outer casing. The initial regions of the outer casing and of the inner casing are then bonded to one another, for example by knotting, by a yam bond or by a plastic or metal clip (what is termed the first clip). The binding must be at least strong enough that it does not part during stuffing and deshirring. The finished tandem casing is then preferably further enclosed with a film packing. The packing serves especially for preventing breaking of the shirred sticks during transport and further handling. The packing further serves for protecting the food casings from contamination with dirt or germs. This shirred food casing (shirred stick) consisting of two segments is novel and is likewise part of the present invention.

During the stuffing operation, the shirred sticks which are positioned one after the other are deshirred simultaneously. The stuffing is then enclosed by two casings, both casings lying smoothly and free from creases against one another or on the contents (for example sausage-meat emulsion). Obviously, for this purpose, essentially equally long sections of the outer casing and the inner casing should be respectively shirred to form a shirred stick. The stuffing can then be performed on one of the customary semiautomatic or fully automatic stuffing, portioning and clipping machines. If appropriate, the product is then boiled or cooked.

The inventive food casing is particularly suitable for producing cooked-meat sausage or scalded-emulsion sausage, but particularly for producing stacked slices. Stacked slices usually means a scalded-emulsion sausage of relatively large caliber (about 40 to 65 mm diameter) which, after the scalding, is cut into slices. In this case the casing is frequently removed before slicing. If the stacked slices are to pass into the market in a film packaging, the casing is regularly removed in advance.

In the examples hereinafter, percentages are percentages by weight unless stated otherwise, or is obvious from the context.

### EXAMPLE 1

A tandem casing is produced from
a) a 20 m long three-layer tubular plastic casing having a flat width of 160 mm and a structure in principle of polyamide/polyethylene/polyamide, shirred to form a 25 cm long shirred stick, and

b) a fiber-reinforced tubular casing based on regenerated cellulose having a flat width of 158 to 162 mm, impregnated with a solution of

| | |
|---|---|
| 20 l | of liquid smoke (® Charsol Supreme Hickory from Red Arrow |
| | Products Co., USA) |
| 24 l | of a 0.2% strength aqueous solution of a heteropolysaccharide |
| | (® Rhodigel 23), |
| 24 l | of a 0.66% strength aqueous solution of a brown food |
| | dye (chocolate brown No. 67775), |
| 6 l | of lecithin, |
| 4 l | of ® Tween 80 and |
| 2 l | of ® Genapol X 080 |

of which likewise 20 m were shirred to form a shirred stick.

The shirred sticks a) and b) were arranged immediately one after the other and the start of the liquid-smoke-impregnated cellulose casing b) was passed through the cavity of the shirred stick a) formed by the outer barrier casing. The start of the two casings was then bound firmly together by a clip. The casings were then stuffed with scalded-emulsion sausage meat on an automatic stuffing, portioning and clipping machine. The sausages thus obtained were then scalded in the conventional manner and peeled after cooling. It was found that the smoke color had transferred uniformly and intensively to the sausage-meat emulsion surface.

### EXAMPLE 2

A tandem casing as in Example 1 was produced, the shirred stick a), however, having a flat width of 180 mm. For the shirred stick b), a tubular cellulose fiber skin (Nalo fiber I) having a residual moisture of 27 to 29% and a flat width of 174 to 177 mm internally coated with a mixture of
1.70 g of protein
0.70 g of alginate
1.80 g of citral
10.0 g of paprika powder and
85.8 g of water

As described in Example 1, the two shirred sticks were combined with one another, stuffed with scalded-emulsion sausage meat and scalded. After cooling, and the surrounding casings were peeled off, it was found that the sausage-meat emulsion surface had taken up the color, flavor and aroma of the paprika as desired.

1. A tubular food casing from which constituents can be transferred to food situated therein, said casing comprising an outer tubular barrier casing and an inner tubular casing which contains and/or carries a transferable colorant, aroma substance and/or flavor substance.

2. The food casing as claimed in claim 1, wherein the outer layer and the inner layer have approximately the same stuffing caliber.

3. The food casing as claimed in claim 1, wherein the outer casing is a seamless single-layer or multilayer casing made of polymer material having a low permeability to water vapor, oxygen and aroma substances.

4. The food casing as claimed in claim 1, wherein the outer casing has an oxygen permeability of 1 to 100 cm³ μm² bar d, determined as specified in DIN 53380, and a water vapor permeability of 1 to 50 g/m² d, determined as specified in DIN 53122.

5. The food casing as claimed in claim 4, wherein the outer barrier casing is a casing based on at least one of polyamide, polyolefin, polyester, poly(vinylidene chloride) (PVDC), poly(vinyl chloride) (PVC), and polystyrene.

6. The food casing as claimed in claim 1, wherein the outer barrier casing is multilayered and comprises at least one layer based on polyamide and at least one layer on layer based on polyolefin.

7. The food casing as claimed in claim 1, wherein the inner casing is produced from (i) regenerated cellulose, (ii) a mixture of thermoplastic starch and/or a thermoplastic starch derivative and at least one polymer (iii) paper, (iv) textile fabric and/or (v) nonwoven fabric.

8. The food casing as claimed in claim 1, wherein the colorant, aroma substance and/or flavor substance is (i) a spice or a spice mixture, (ii) a spice extract, (iii) a liquid smoke or dry smoke, (iv) a natural or synthetic aroma and/or a (v) flavor enhancer.

9. The food casing as claimed in claim 1, wherein the colorant, aroma substance or flavor substance is combined with a binder.

10. The food casing as claimed in claim 9, wherein the binder is a polysaccharide, a modified starch, dextran, pullulan, tragacanth gum, xanthan gum, gum arabic, alginate, methyl cellulose, hydroxyethyl cellulose, hydroxypropyl cellulose, carboxymethyl cellulose, chitin, chitosan, a protein, pectin, carrageenan, guar and/or gelatin.

11. The food casing as claimed in claim 9, further comprising a component which decreases water solubility that is added to the colorant, aroma substance or flavor substance and/or the binder.

12. A shirred tubular food casing which comprises a first segment and a second segment arranged immediately one after the other, the first segment comprising a shirred tubular barrier casing and the second segment comprising a tubular casing which contains and/or carries at least one transferable colorant, aroma substance and/or flavor substance.

13. The food casing as claimed in claim 12, wherein a portion of said second segments comprises a deshirred or non-shirred portion which is passed through a cavity of the first segment and firmly bonded thereto.

14. The food casing as claimed in claim 12, wherein the two segments are bound to one another by a plastic clip or a metal clip.

15. A method for producing cooked-meat or scalded-emulsion sausage, in particular stacked slices comprising employing a food casing according to claim 1.

16. The food casing as claimed in claim 2, wherein the outer casing is a seamless single-layer or multilayer casing made of polymer material having a low permeability to water vapor, oxygen and aroma substances.

17. A casing according to claim 4, wherein said oxygen permeability is from 1-10 cm³/m² bar d, and said water vapour permeability is from 1-10 g/m² d.

18. The food casing as claimed in claim 2, wherein the outer barrier casing is multilayered and comprises at least one layer based on polyamide and at least one layer based on polyolefin.

19. The food casing as claimed in claim 2, wherein the inner casing is produced from (i) regenerated cellulose, (ii) a mixture of thermoplastic starch and/or a thermoplastic starch derivative and at least one polymer, (iii) paper, (iv) textile fabric and/or (v) nonwoven fabric.

20. The food casing as claimed in claim 2, wherein the colorant, aroma substance and/or flavor substance is (i) a spice or a spice mixture, (ii) a spice extract, (iii) a liquid smoke or dry smoke, (iv) a natural or synthetic aroma and/or a (v) flavor enhancer.
